(19) United States
(12) Patent Application Publication
(10) Pub. No.: US 2005/0161520 A1
(43) Pub. Date: Jul. 28, 2005

(54) Heating system, method for operating a heating system and use thereof

(76) Inventor: Karl Heinz Gast, Aurachtal (DE)

Correspondence Address: LERNER AND GREENBERG, PA, P O BOX 2480, HOLLYWOOD, FL, 33022-2480, US

(21) Appl. No.: 10/505,601

(22) PCT Filed: Feb. 24, 2003
(86) PCT No.: PCT/EP03/01837

(30) Foreign Application Priority Data
Feb. 22, 2002 (DE) 102 07 635.9
Jul. 27, 2002 (DE) 102 34 270.9

(51) Int. Cl. G05D 23/00

(52) U.S. Cl. 237/12

(57) ABSTRACT

The invention relates to a heating system for generating and distributing thermal energy, comprising one or more circulation systems for distributing the heat, heating circuits for generating heat and at least one storage element (14). For economical storage of large amounts of heat and in order to improve the efficiency of the system, the heating system is dependent on a level of fluid and the circulation systems, e.g. for heating (23-29), storage connection, domestic water heating (26, 30-32), after-heating, heat exchange, storage collectors (5, 7-10), heating boiler (33-38), heating pumps, procurement of heat and cooling, are connected directly to the storage element (14), whereby the storage fluid is used directly by the circulation systems. Supply devices, such as filling devices (26, 30) or (34) or devices increasing the level of fluid, introduce the fluid into the circulation system before circulation and/or supply devices keep the fluid in the circulation system and/or the circulation systems dependent on the level of fluid are provided with a emergency filling device (31, 33). The invention also relates to a method for operating a heating system and to the use thereof.

The invention relates to a heating system for generating and distributing thermal energy, the heating system comprising one or more heating circuits for distributing the heat to heat exchangers, such as radiators and/or floor heating and/or wall heating and/or service water heat exchangers, and/or heating circuits for the generation of heat, for example by means of collectors and/or heating boilers and/or heat pumps, and comprising at least one reservoir.

Heating systems as defined in the introduction with circulating and storage systems which are predominantly under superatmospheric pressure are known from the general prior art. However, heating systems of this type have the drawback that solar circulating systems are coupled to the reservoir by means of a heat exchanger in order to allow operation to be protected against frost by means of a water-glycol mixture, resulting in losses and reductions in efficiency. Furthermore, the superatmospheric pressure reservoirs have to be designed with hand holes or entries or flange connections for heat exchangers or stratification tubes with a corresponding stability with respect to pressure, which places high demands on the materials, and can only be designed in modular form with very great difficulty.

To avoid the use of water-glycol mixtures, the publications DE 28 39 258 A1, DE 195 15 580 A1 and DE 43 38 604 A1 have disclosed arrangements in which the solar collector is separated from the pressure system and the solar collector is evacuated by gravity if there is a risk of frost and the water is pumped back into the collector or into the superatmospheric pressure circulating system. Although this means that it is possible to do without a heat exchanger for the collector circulating system, it is necessary to use superatmospheric pressure reservoirs, with the following drawbacks compared to unpressurized reservoirs:
limited use of store materials (generally only steel)
“tested superatmospheric pressure” safety measure
release of excess pressure through pressure relief valves
expansion vessels for pressure holding
difficulty of access, for example for fitting stratification tubes
higher demands imposed on material strength and weld seams

One further known option is to use unpressurized reservoirs with circulating systems that are subjected to pressure. In this case, however, the heating circuit is linked via a heat exchanger in the reservoir. This likewise entails costs for the heat exchanger, pressure losses in the heating circuit and losses of efficiency at the heat exchanger and in the circulating system.

Laid-open specification DE 196 08 405 A1 has disclosed a closed solar installation which comprises a pressurized store with a glass pocket. The water can flow back from the solar collector into the reservoir through an emptying apparatus. The solar collector can be refilled by an additional feed pump connected in parallel with the recirculation pump. A solar collector installation of this type is only suitable for a maximum collector height of up to 7 m and even then can only be operated with a reduced temperature. If a greater height is required, the installation has to be pressurized. This in turn requires pressure reservoirs. The advantages of an open store are not available with an installation of this type. Moreover, it is then necessary to ensure that the pressure safety requirements are satisfied.

It is known from laid-open specification DE 27 53 810 A1 that a solar collector circulating system is operated at a store, the reservoir being closed and the return into the gas pocket opening out in the reservoir. This arrangement has the drawback that it is impossible for there to be any temperature-dependent stratification in the reservoir. The circulation requires a relatively strong pump with corresponding operating costs. The through-flow must be sufficiently strong for the pressure generated in the collector to be high enough for the water in the collector not to boil even at low temperatures. This means strong mixing in the reservoir.

Laid-open specification DE 26 14 142 A1 has disclosed a closed circulating system for solar installations which is provided with a compensation vessel, a return tube ending below the water level in the compensation vessel and a return tube which can be controlled by solenoid valve opening out in the gas region of the compensation vessel. Opening the solenoid valve allows the collector to empty out under the force of gravity. However, to introduce heat into the reservoir, a circulating system of this type requires a heat exchanger, with the associated drawbacks of pressure losses, efficiency losses, costs and outlay on materials. The compensation vessel and the pump need to be fitted as closely beneath the collector as possible. Since attic floors are often also built in nowadays, this means arranging this apparatus outside the house, with additional outlay for insulation and sealing as well as the drawback of poor accessibility for maintenance.

A further closed circulating system with a compensation tank is known from DE 196 54 037 C1. In this case, a connection from the collector feed to a water tank is produced via a flow-controlled three-way valve, so that the collector is emptied when the circulation is inoperative. In this installation too it is necessary to use a heat exchanger, with the drawbacks listed above.

Working on the basis of a heating system in accordance with the preamble of claim 1, the invention is based on the object of designing this heating system in such a way, while avoiding the drawbacks of the known heating systems, that greater quantities of heat can be stored economically and the installation efficiency is improved. Further objects are to improve the operational reliability and the protection of the heating system against corrosion. Furthermore, it is intended that there should be a greater choice of materials which can be used. The development of further heat sources and the storage of the heat from these sources is intended to extend the heating system.

According to the invention, the object is achieved by the features given in the characterizing clause of claim 1, namely by the fact that
the heating system is subject to a fluid level,
and that circulating systems, such as heating circulating systems, store coupling circulating systems, service water heating circulating systems, reheating circulating systems, heat exchanger circulating systems, store collector circulating systems, heating boiler circulating systems, heat pump circulating systems, heat-obtaining circulating systems, cooling circulating systems, are directly connected to at least one store, so that the storage fluid is directly circulated through the circulating systems,
wherein provision devices, such as filling devices, or devices which increase the fluid level, introduce the fluid into the circulating system before it is circulated,
and/or wherein retaining devices retain the fluid in the circulating system, such as cyclical or event-controlled or constant minimal circulation or recirculation phases when inoperative and/or additional sealing measures for components, such as screw connections, fittings, valves, and/or the blocking of circulating systems while they are at a shutdown and/or increased quality assurance for circulating system and/or devices which increase the fluid level,
and/or wherein heating systems which are subject to fluid level are equipped with an emergency provision device, such as manually actuated or short-term operation pumps, diaphragm vessels, gas pressure vessels, valves leading to the water mains or domestic water system or devices which increase the fluid level, or with a connection for an emergency provision device.

Advantageous refinements of the heating system are given in claims 2 to 45.

The invention also relates to a method for operating a heating system, in particular as claimed in claims 1 to 45, which accordingly is based on the same object as the heating system. In terms of the method, this object is achieved by the features given in the characterizing clause of claim 46, namely by virtue of the fact
that the pressure-holding is dynamic, for example that the pressure is built up with dynamic pressure generation (5, 24), such as a recirculation pump or a series connection of pumps or by means of a positive displacement pump or by means of a pressure pump, and is held by means of a device (12, 20) which generates a back pressure, such as a valve or a turbine or an impeller or a flow body or flow flaps or adapted lines or nozzles or slides or a distribution device, so that a defined part of the pressure generation manifests itself in an increase in the pressure in the circulating system and not in an increase in the through-flow,
and/or that the dynamically generated pressure energy is recovered again, for example for pressure-holding and/or recirculation and/or provision and/or to protect against corrosion,
and/or that to empty and/or provide the fluid in a circulating system, the fluid in the circulating system is exchanged with the gas from an inert gas region or with air, the fluid passing through the inert gas region and/or across a gas section via the reservoir or returning directly to the reservoir (14) via a zone with decelerated flow or a stratification device (16, 19), predominantly a stratification device or zone which is already used in some other way,
and/or that heating systems can empty circulating systems or parts of circulating systems which are directly linked to the reservoir, the fluid level of the reservoir projecting into the region that is to be emptied,
and/or that heating systems, for reliable emptying, record the fault using sensors and/or reliably ensure emptying by means of redundant elements and/or by means of repetition operations and/or by means of autonomous additional devices,
and/or that to protect against corrosion gas is collected in and/or outside the heating system and the oxygen is bonded in the gas,
and/or that to seal components, such as screw connections and/or fittings and/or valves, a flexible hose or a shrink-fit hose with seals is drawn over the components, the flexible hose used predominantly being a silicone hose,
and/or that devices for providing and/or retaining and/or circulating and/or pressure-holding and/or emptying fluid in circulating systems by means of central and/or distributed devices in a heating system act on a plurality of circulating systems simultaneously or, by switching, act on the particular cycle circuit independently of one another with the abovementioned functions,
and/or that for venting purposes the or parts of the heating system are dynamically pressurized, such as circulating systems which are blocked off using valves and are pressurized with the aid of the provision device and are vented via float-controlled vent valves combined with a pressure relief valve,
and/or that in the event of the flow being broken off or in the event of insufficient flows in circulating systems, the control device automatically switches on provision phases or flow-increasing phases,
and/or that to prevent the ingress of air circulating systems or parts thereof can be emptied,
and/or that to protect against frost and/or to prevent boiling in circulating systems, in addition to solar collector circulating systems other external circulating systems or circulating systems or parts thereof that are not protected against frost, such as circulating systems for heating and removing heat from storage compounds or storage solar collectors or for obtaining heat or for cooling, can be emptied,
and/or that a layer is applied to the fluid level(s) in the heating system, a floating layer (15), such as paraffin oil, predominantly being used for this purpose,
and/or that to protect against corrosion the fluid pressure in the heating system or in parts of the heating system is dynamically altered.

Advantageous refinements of this method are given in claims 47 to 76.

The invention also relates to the use of devices of the heating system in such a form that devices as described in claims 7 to 12 and 16 to 44 are used for heating systems which are under superatmospheric pressure or other unpressurized or emptyable or pressure-reduced circulating systems.

The abovementioned claims result in the advantages described below.

In modern heating systems, for solar storage in order to avoid a high switching rate in the heating boiler, water reservoirs are increasingly being used as an intermediate store if it is necessary to shut down, for example in the case of heat pumps, for the coupling of fresh water stations, etc. The use of unpressurized fluid heat reservoirs in the heating system improves the economics and also the functions, such as larger heat reservoir volumes, additional internal fittings for stratification, internal fittings of sensors or for heat recovery.

Moreover, an unpressurized hot water store offers the advantage of saving material in the design of reservoirs of this type, since this and the flanged connections do not have to be designed for superatmospheric pressure, and consequently in addition to materials which corrode it is also possible to use increasingly expensive corrosion-resistant materials. A store of this type can also simply be welded or soldered or assembled on site, with the result that better matching to the local conditions can be achieved. Moreover, there is a greater freedom of choice in terms of the material which can be used for the reservoir (e.g. plastic, concrete, steel, sealed brickwork, etc.).

A modular construction of reservoirs of this type is also simplified or even made possible for the first time. Consequently, larger reservoirs can be introduced and assembled on site.

These widened options can lead to reservoirs of lower cost, so that larger reservoirs can be employed for optimum utilization of the solar energy, resulting in better boosting of the heating by means of solar energy.

Furthermore, in the case of an unpressurized store, the accessibility is improved. By way of example, this fact can be utilized to allow integration of stratification systems or additional latent reservoirs.

The improved accessibility also offers benefits during maintenance, for example it is easier to carry out repair on the stratification system, with the result that it is also possible to achieve advantages with regard to service life and/or duration of usage of the materials employed.

With the storage fluid used directly as heat-transfer liquid in the circulating systems, without heat exchangers being connected in between, it is possible to achieve a high level of efficiency of the heating system as a whole, firstly when obtaining the thermal energy in the solar collector, since water has a higher heat capacity than water-glycol mixtures, and secondly through avoiding the heat exchanger losses.

When the heat is released in the heating circuits, it is likewise possible to avoid heat exchanger losses through direct recirculation of the storage water.

Heat exchangers, safety valves, pressure compensation vessels, store entry access points or handholes, which are expensive in terms of materials, the ability to dismantle the stratification system, vent apparatuses, can be eliminated in this unpressurized heating system.

The protection against corrosion is improved, since the oxygen which penetrates is not oxidized by corrosion at the components, but rather converted by active elements. Monitoring of the penetrated oxygen can even give rise to intervention in the system so that unsealed locations are eliminated.

When the circulating system is inoperative, there is inert gas in the heating system, so that nowhere is there any included penetrated air, as in a pressure system, which leads to corrosion, but rather the penetrated oxygen can be actively converted in the inert gas tank, since the circulating system is then in communication with the inert gas tank.

All the corrosion-resistant measures of the heating system, such as those mentioned above and others, mean that a longer service life of the installation is to be expected, thereby increasing material productivity.

The abovementioned advantages give rise to the question of why unpressurized or fluid level heating systems of this type have not already been developed earlier. The answer lies in a range of problems which have to be resolved.

Hitherto, it has not been possible to protect installations of this type against corrosion, since unpressurized circulating systems may slip into the subatmospheric pressure range, with the result that air can easily be drawn in. Indeed, the very purpose of a superatmospheric pressure circulating system is to prevent the penetration of air by means of superatmospheric pressure.

The fact that it is easy for air to penetrate means that the circulation is not sufficiently operationally reliable to comply with the requirements of modern systems in order also to keep maintenance costs at a low level. In circulating systems which are under a subatmospheric pressure, the venting using automated vent devices or vent valves fails to function, since these devices would in fact promote the ingress of air when under a subatmospheric pressure.

With collector heights, for example, of over 7 m, the subatmospheric pressure is so great that the heat-transfer medium water boils even at low temperatures, and therefore a higher temperature yield would be impossible on account of the disrupted circulation.

The use of high-power pumps to solve this problem is not economical on account of the higher operating costs and the lack of standard pumps for the high temperature range.

The filling of unpressurized circulating systems requires high-performance circulation which is able to mix the stratified arrangement in the reservoir.

Hitherto, there has been no comprehensive solution concept for various installations (e.g. different store heights or collectors fitted at a very high level).

In the text which follows, the heating system and the method for operating a heating system are explained in more detail with reference to the drawings, which illustrate a number of exemplary embodiments. In the drawing, in some cases in diagrammatic form:

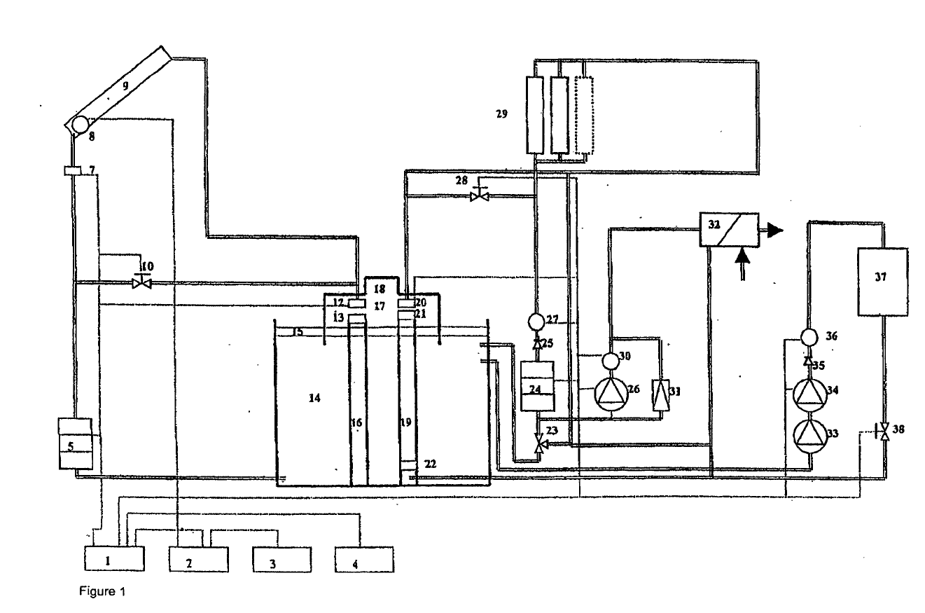

FIG. 1 shows a heating system with unpressurized fluid heat reservoir

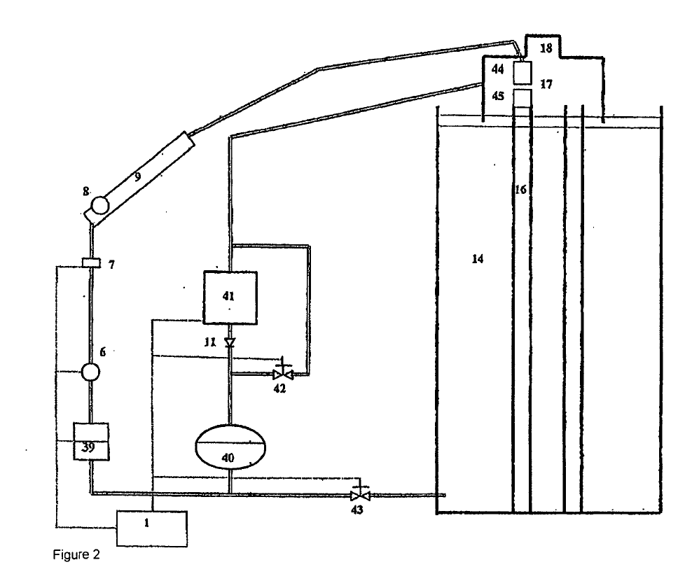

FIG. 2 shows a heating system with a fluid level above the emptying level

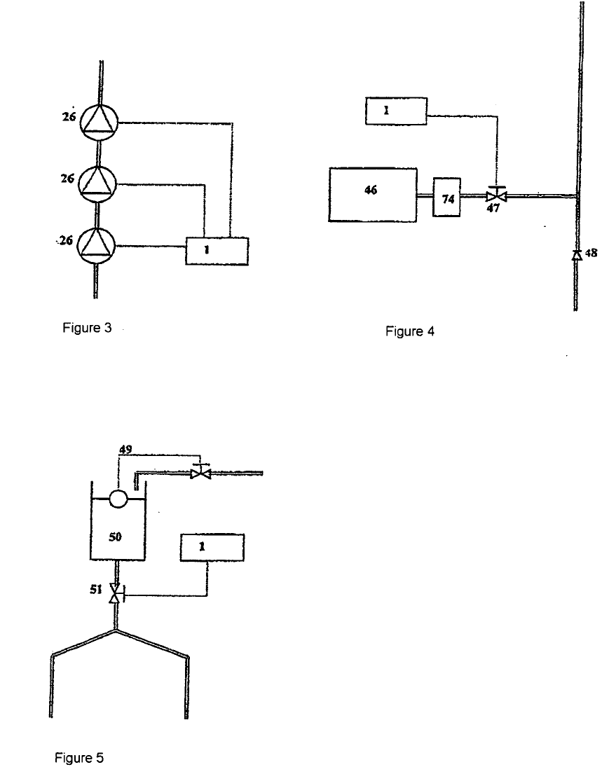

FIG. 3 shows a filling device with a series circuit

FIG. 4 shows a filling device with domestic water system

FIG. 5 shows a filling device with reservoir tank

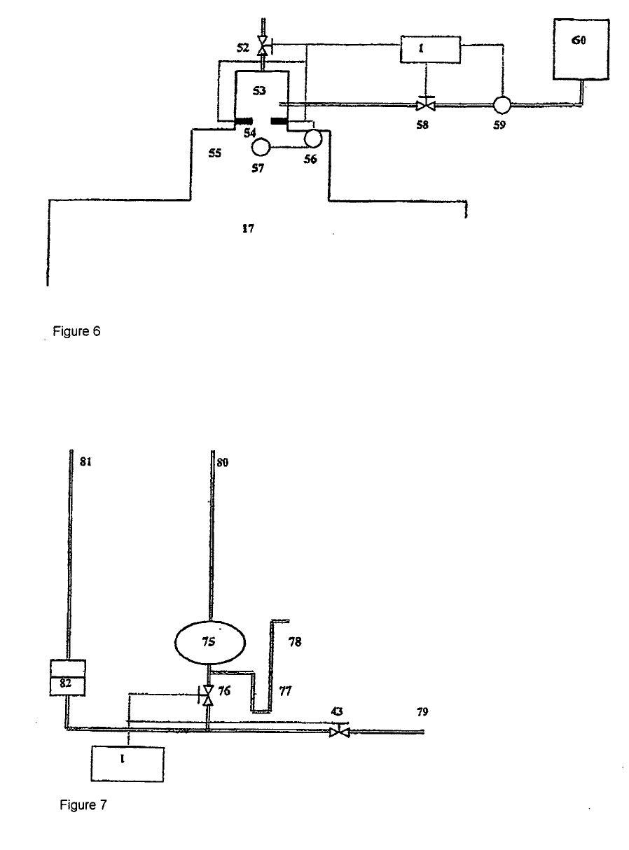

FIG. 6 shows a hydrogen-oxygen reactor

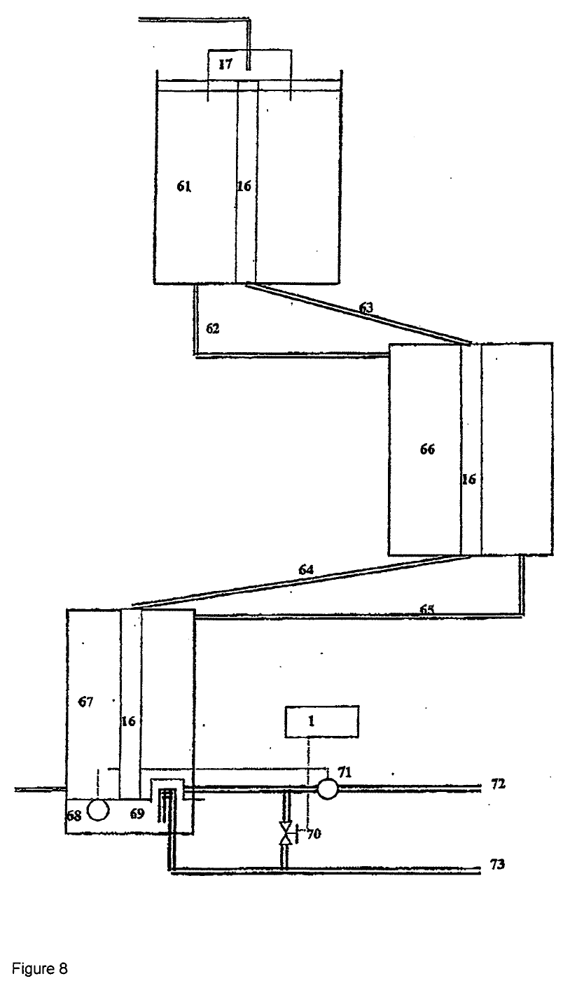

FIG. 7 shows an emptying device

FIG. 8 shows a store assembly with heat recovery

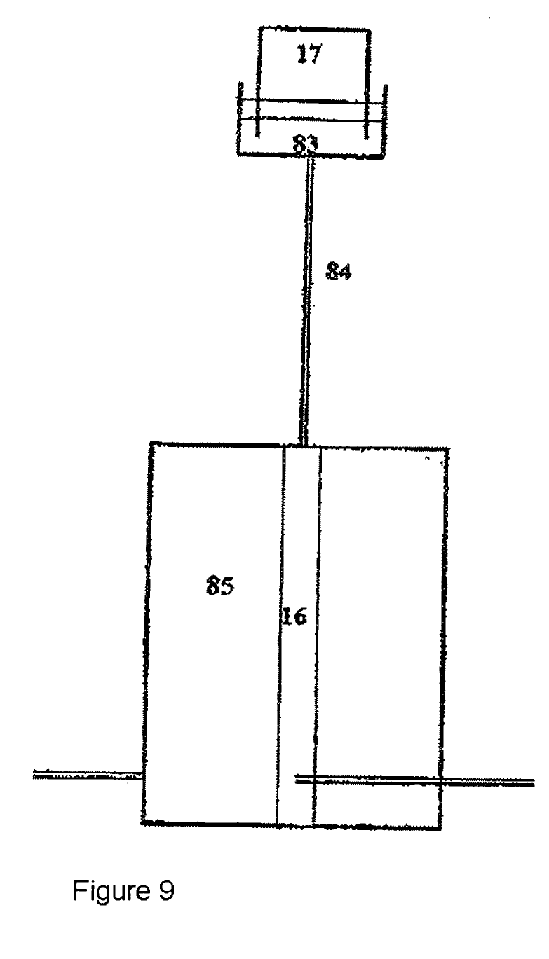

FIG. 9 shows a device for increasing the fluid level.

An embodiment of a heating system which is in accordance with the object set is shown in FIG. 1. It comprises an unpressurized store (14) and a plurality of unpressurized circulating systems in various designs. The circulating system for the heating boiler (37) shows a simple design of a circulating system of this type. When commissioning the installation, the circulating system is filled by the emergency filling device, in this case a manually actuated series connection of the circulation pump (34) and a further emergency filling circulation pump (33). For this purpose, the blocking valve (38) has to be opened by the control unit. After filling has taken place, the blocking valve (38) is closed, and the fluid is held in the cycle circuit by means of the nonreturn valve (35) and the closed blocking valve (38), thereby preventing the ingress of air. If the circulating system were not closed, the fluid could slowly escape from the circulating system, since the upper part of the circulating system projects above the fluid level in the reservoir (14) and would therefore be under subatmospheric pressure. The higher the circulating system projects upward with respect to the fluid level, the greater the subatmospheric pressure. This subatmospheric pressure would cause the circulating system to suck in air and the fluid would escape, and consequently after a certain time the circulating system would no longer be operable by means of the recirculation pump. Blocking off the circulating system by means of the blocking valve (38, 35) keeps the circulating system ready to operate. Therefore, if it is required for the heating control (4) to perform recirculation, the control unit (1) merely has to open the blocking valve (38) and enable the recirculation pump, with the result that the fluid from the reservoir can be circulated with an operating energy similar to pressure systems. The retention in blockable circulating systems can be increased still further by the pressure generation for filling and/or pressure-holding and/or for circulation remaining or being switched on during the blocking operation until the blocking operation has ended. The increased pressure reduces or avoids the occurrence of subatmospheric pressure and the air is kept out of the circulating system.

A further variant embodiment for retaining the fluid in the circulating system is represented in the circulating system for the service water heat exchanger (32). During commissioning, the circulating system is filled once by means of a manually actuated emergency filling pump. From this instant on, the fluid is held in the cycle circuit by virtue of a short recirculation phase being switched on cyclically by the control unit (1) when the cycle circuit is inoperative. This means that the cycle circuit with the recirculation pump (26) can likewise be operated with a low operational energy in the event of a demand for hot service water. To minimize the number of recirculation phases which are initiated while the system is inoperative, these phases can also be triggered on an event-controlled basis, for example by a sensor detecting the absence of fluid, arranged at the level of the circulating system in which the recirculation pump is still active. The screw connections and fittings and valves in the cycle circuits may additionally also be sealed with the aid of additional sealing measures, such as flexible hoses or caps which can be pulled over them or multiple seals or seals which can be pressed on from the outside or a combination of threaded sealing filling materials and seals or the application of coatings or resins, so that the operational readiness of the circulating system is increased further. For sealing purposes, a flexible hose or a shrink-fit hose with seals is pulled over the screw connection and/or fittings, the flexible hose used predominantly being a silicone hose, and it being possible for a sealing material to be arranged between hose or shrink-fit hose and screw connection or fitting.

Additional quality measures, such as applying an increased pressure to the circulating system or screw connection securing means and/or monitoring of the leaktightness of circulating systems, such as pressure-holding measurements, fluid level measurements in the circulating system when it is inoperative, measurements of the introduction of gas, also increase the readiness and installable height of circulating systems of this type. Securing screw connections such that they cannot become detached, for example by means of metal plates which are fixed on one side and are bent onto surface, such as the screw head face, also maintains readiness for a longer period of time.

The monitoring of the circulation by means of simple flow sensors (30, 36), such as flow-actuated flaps or plates which are held in a preferred position and deliver, for example, a magnetic signal as a function of their position, also protects the pump against destruction and supplies information on the actuation of the emergency filling.

The use of flow sensors, including in combination with temperature sensors, also enables the filling and circulation of the circulating systems to be monitored and/or subject to closed-loop and/or open-loop control as a function of power, flow, volumetric through-flow and/or heat quantity. This allows increased operational readiness and heat conversion calculations and provision of heat quantities in accordance with the heat conversion.

The use of positive displacement pumps for recirculation and pressure-holding also improves the operational readiness of the heating system.

In the case of the circulating system for the heating heat exchanger (29), it is assumed that this is a complicated, extensively branched circulating system of increased height with respect to the fluid level of the reservoir, with a large number of screw connections, fittings and valves being installed. With unpressurized circulating systems of this type, the problems arise whereby when the circulating system is inoperative, a considerable subatmospheric pressure may occur on account of the greater height. Consequently, complete gas tightness cannot be achieved in the circulating system.

According to the invention, this problem is solved by the fact that in circulating systems of this type a provision device which, in the event of the need for circulation, first of all fills the circulating system with fluid and then gradually transfers it to recirculation mode and pressure-holding mode, is used. The pressure for the filling, recirculation and pressure-holding (24) can be generated by means of a pump which, with the aid of the control unit and sensors, such as the flow sensor (27), and a pressure-holding device provides open-loop or closed-loop control of the pressure generation in accordance with the functions of filling, recirculation and pressure-holding.

However, for the filling device it is also possible to use alternative pressure-generating devices which are put into operation in the event of a demand for recirculation or in the event of the circulating system not being ready and are then transferred to recirculation mode and pressure-holding mode, such as a diaphragm vessel (FIG. 2). In this case, a compressor (41), which sucks in the gas from the inert gas tank (17), for example, generates a gas pressure, so that the fluid in the diaphragm vessel (40) is displaced and, with the blocking valve (43) closed, fills the circulating system. The nonreturn valve (11) and the pressure relief valve (42) maintain the pressure while the circulating system is operating, so that the diaphragm vessel (40) remains empty of fluid. To empty the circulating system, it is possible to relieve the gas pressure using the pressure relief valve (42), so that the fluid runs out of the circulating system into the diaphragm vessel with the blocking valve (43) closed. As an alternative to the diaphragm vessel, it is also possible to use an upwardly facing pressure vessel. A pressurized gas storage system or a domestic water system or a pressure pump can also be used to generate the pressure. As a result, the filling device can be connected to existing pressure-generating devices, thereby further improving the economics.

The filling device, comprising a series circuit of standard recirculation pumps (FIG. 3) and sufficient actuation of the pumps by a control device, is also more economical than a large pump, since smaller pumps are produced in greater numbers. In the case of installations with a large number of circulating systems and therefore a large number of recirculation pumps, it may also be expedient for these recirculation pumps, in order to be filled, to be connected in series and to the cycle circuit that is to be filled.

FIG. 4 shows a further economic form of filling. By means of the domestic water system (46), water is passed across an oxygen-bonding unit (74), so that when the filling valve (47) is open water is passed into the circulating system. The nonreturn valve (48) controls the direction of filling. After the circulating system has been filled, the control device closes the filling valve (47), so that the domestic water system is disconnected, and the circulating system can be operated. Filling with a fluid reservoir (FIG. 5), for example from a tank (50) or a fluid heat reservoir, may also be appropriate. In this case, for filling with a filling valve (51), fluid from the reservoir can be added to the circulating system. The reservoir can be built up by means of a level-controlled valve (49) to the domestic water system or to the water mains or during recirculation.

If none of the filling devices mentioned above can be used, the filling device may also comprise a control device and a positive displacement pump or a pressure pump.

All the filling devices can be used for emergency filling, and the valves may be replaced by manually actuated slides and the electrically actuated or controlled devices may be replaced by manually actuated or manually controlled devices or devices designed for short-term operation.

If the height of the circulating system is 10 m above the fluid level of the reservoir (14), a subatmospheric pressure of virtually zero prevails in this region of the height of the circulating system. This would mean a corresponding drop in the boiling point of the water. In the case of circulating systems which none the less have to be operated at a higher temperature and for circulating systems which project above 10 m, a pressure-holding means has to supply the required pressure. The dynamic pressure-holding means comprises a pressure generation device (24) and a device (20) which generates back pressure, such as an adjustable or controllable valve, turbine, impeller, flow body, flow flap, modified line, nozzle, slide, distribution device or the like. As a result, the pressure generation manifests itself not as an increase in flow, but rather as the desired increase in pressure in the circulating system (FIG. 1).

The pressure which is currently required can be maintained by means of a control device which controls the resistance of the device generating back pressure as a function of the pressure in the circulating system and of a desired pressure value, which is slightly above the current boiling pressure value of the circulating system. The additional control of the pressure generation as a function of the current flow value of the circulating system and the desired flow value of the required circulation allows operating energy to be saved compared to fixedly set worst case settings.

Static pressure-holding when inoperative by means of blocking of the circulating system with the aid of a closable device (20) generating back pressure and the nonreturn valve (25) causes the pressure in the circulating system to be held rather than having to be generated afresh each time the recirculation is interrupted briefly. Switching on the pressure generation for filling, pressure-holding and circulation during blocking of the circulating system avoids a subatmospheric pressure in the circulating system and keeps the air out of the circulating system.

Vent phases can be switched on in the case of extensively branched circulating systems that are difficult to vent. By way of example, a filling phase or a flow-increasing phase can be switched on during the circulation if a low flow rate is measured.

A further possible venting option consists in blocking the circulating system during filling, so that the pressure of the filling is held and included gas is discharged at the corresponding vent points with vent valves. However, in addition to the float-controlled valve, these vent valves also have to be combined with a pressure relief valve, so that on the one hand the excess gas pressure in the circulating system is reduced, but on the other hand it is impossible for any air to penetrate in the event of a subatmospheric pressure in the circulating system.

Since unpressurized circulating systems may slip into the subatmospheric pressure range or may even be operated at a subatmospheric pressure in order to minimize operating costs, they are the diametric opposite of superatmospheric pressure systems, since the purpose of the superatmospheric pressure is to keep the air out of the circulating system and therefore to achieve effective protection against corrosion.

In this heating system, this problem has been solved with the aid of an inert gas tank (17), (FIG. 1, 2, 6), which is arranged above the reservoir (14) over the stratification tubes (16, 19). The inert gas tank (17), which is open toward the reservoir (14) or stratification tube (16, 19), can first of all transfer the fluid from the return of the circulating system (29, 9) opening out into it to the stratification tube (19, 16), and therefore also transfer it into the reservoir, and can secondly collect the gas from the circulating system which is entrained by the flow of fluid during filling and recirculation, and thirdly the gas can be reused and/or exploited for other purposes.

In one simple embodiment of the protection against corrosion, after the installation has been commissioned, the oxygen will corrode, so that substantially an inert gas is to be found in the inert gas tank. Opening the pressure-holding valve (20) and the emptying line with the emptying valve (28) allows the fluid to be exchanged with the inert gas when the circulating system is inoperative, so that a subatmospheric pressure in the circulating system is avoided and therefore protection against corrosion is provided. Filling the inert gas tank with a slight superatmospheric pressure also allows exchange to take place more quickly, and consequently only slight subatmospheric pressures are produced during the exchange. Moreover, this means that in the gas-filled state of the circulating system, a slight superatmospheric pressure is also provided in the circulating system, so that the air can be kept out of the circulating system.

In addition to the functions of gas collection and/or fluid gas exchange, the inert gas tank (17) can also perform and/or integrate further functions, such as gas separation and/or oxygen bonding and/or energy recovery and/or transfer from and into a stratification device and/or the stratification and/or the increasing of the fluid level and/or the uptake of fluid from emptying and/or from the thermal expansion of the fluid and/or the increasing of the fluid level, and an inert gas tank may also apply these functions to a plurality of circulating systems.

The arrangement of the functions in or at a spatial distance from the reservoir and/or spatially distributed in different tanks, and the fact that they are connected to one another and to the reservoir or to the stratification system by means of transfer devices, which can also be switched by means of valves, facilitates spatial accommodation under various conditions. The gas collection in, next to or above or within the fluid store or fluid tank or in the circulating system also improves the flexibility of arrangement.

The inert gas tank (17) has a gas-permeable opening leading to the reservoir or to the stratification system in or at the reservoir or fluid tank, so that the gas bubbles from the stratification system or recirculating system are collected in the inert gas tank. As a result, it is also possible to feed the returns from the circulating systems into the reservoir or directly into the stratification duct. To separate gas, the tubes which open out into the reservoir or fluid tank or inert gas tank (17) and therefore the fluid which opens out are routed via a gas section and via distribution devices (44), such as spray heads, spray tubes, spray plates or outlet slots, outlet holes, outlet windows, over a large area or with a fine distribution through the gas space. This makes it easy for micro- or macro-bubbles of gas which are present in the fluid to escape from the fluid and be collected in the inert gas tank, the distribution devices also being of gas-separated and funnel-shaped design, so that macro-bubbles can escape upwards, resulting in automatic adaptation to the current flow.

The arrangement of the inert gas tank (17) in the circulating system is preferably in the return of the circulating system or in the reservoir or fluid tank or above the reservoir or fluid tank above the stratification system or above return tubes which open out into the reservoir or fluid tank. The inert gas tank (17) or the gas-trapping apparatus or fluid-transfer apparatus may also be arranged floating, submerged or with an adjustable height or in a rigidly secured position in or above the reservoir (14) or fluid tank or stratification system (16, 19) or the return of one of more circulating systems.

The inert gas tank (17) is of unpressurized or pressurized design, so that it correspondingly matches the design of the reservoir or the arrangement of the inert gas tank.

By accurate pressure monitoring of the gas pressure in the inert gas tank over the course of time, it is possible to recognize the lack of leaktightness of the inert gas tank and the circulating systems, so that sealing measures or the activation of oxygen-bonding units can be implemented. An increase in the pressure over the course of time indicates that subatmospheric pressures occur in the circulating system, resulting in the introduction of air. A reduction in the gas pressure indicates that there are leaks, which means that inert gas is escaping. Moreover, the pressure measurements have to be carried out under the same conditions, such as temperature and filling levels, of the circulating systems, or else the measurements have to be converted by calculation to equate to identical conditions.

If complete leaktightness of the circulating system cannot be ensured, for example on account of the use of a large number of valves or gas-permeable tubes, the problem arises that carbon dioxide and oxygen are introduced. During filling and circulation in the circulating systems, these gases are partially dissolved in the fluid. The dissolution of carbon dioxide in water produces carbonic acid, which leads to corrosion of the components. Therefore, in modern heating systems, the inert gas used is not a nitrogen/carbon dioxide mixture, even though both gases are inert gases. This problem is solved by the fact that the return is routed via a lime filter (21), so that the carbonic acid is neutralized.

In addition, the water is degassed again by means of the oil layer (15), predominantly comprising paraffin oil, on the reservoir water, since hot water has a lower solubility and the heated water releases the dissolved gas so that this gas can rise outwards through the oil layer (15) whereas it is impossible for any further gas to be taken up on account of the water being shielded by the oil layer (15). The oil layer (15) also prevents corrosion of the edges of the reservoir in the event of changes in the fluid level as a result of emptying and filling of the circulating systems. This is because the thickness of the oil layer is greater than the change in water level. Moreover, the oil layer prevents the evaporation of the reservoir water and allows free accessibility to the reservoir. In addition, the oil layer can cause the gas above it to dry out, since during cooling of the reservoir the cooled gas releases moisture which, as drops of water, can sink through the oil layer but the oil layer also means that it is impossible for any moisture subsequently to rise upwards. The oil layer can be applied to all the fluid levels in the heating system, for example including in the water collection tank or inert gas tank.

The introduced oxygen is bonded in the inert gas tank (17) by an oxygen-bonding unit, so that it cannot cause corrosion at the components. In a single design, this can be realized using an iron filings filter (21) which is wetted by the return water of the circulating system, so that the iron filings, through corrosion, bond the oxygen in the inert gas tank in the form of iron oxide. Other formations, such as iron materials with an increased surface area, for example iron foams or laminated assemblies or sheet-metal coils or perforated metal sheets with spaces for water wetting, can also be used to good effect. The activity and therefore the oxygen-bonding capacity can be increased by partially immersing the iron filings filter in the water and by applying an electric voltage between the iron and the water. This arrangement then forms an electrochemical element, with the result that the corrosion of the iron filings filter is increased. This effect can also be generated by means of a metal which is further away in the electrochemical series, such as copper, in which case the copper is likewise immersed in the water, for example by means of copper wires which project into the iron filings filter and are likewise wetted by the return water. In addition to the bonding of the oxygen from the gas region, the dissolved oxygen in the water is also bonded. Magnesium may also be used instead of iron.

If the level of oxygen introduced is very high, the oxygen bonding can be enhanced by means of a combustion unit (18) which is supplied with hydrogen and bonds the oxygen to form water by means of hydrogen combustion. This can be effected using a burner flame or using a hydrogen-oxygen reactor or by means of a fuel cell.

An exemplary embodiment with a hydrogen-oxygen reaction device integrated in the inert gas tank is shown in FIG. 6. Two regions are formed at the highest point in the inert gas tank (17). The hydrogen-oxygen reaction takes place in the hydrogen-oxygen reaction region (53). The hydrogen monitoring region (55) located beneath it is used to ensure that there is no more hydrogen in the tank than the amount desired for the defined hydrogen-oxygen reaction. The control device (1), by opening the hydrogen inlet valve (58) from the hydrogen tank (60), admits a defined quantity of hydrogen into the hydrogen-oxygen reaction region (53). The quantity can be determined by means of the flow sensor (59). Since hydrogen is the lightest gas and the hydrogen-oxygen reaction region (53) is located at the highest point in the inert gas tank (17), the hydrogen remains in the hydrogen-oxygen reaction region (53). It is attempted to ignite the hydrogen by means of an ignition means (54). If there is oxygen in the inert gas tank (17), a hydrogen-oxygen reaction takes place, but otherwise does not. The control device (1) attempts to effect ignition cyclically until a hydrogen-oxygen reaction is detected by means of a reaction flow sensor (57) arranged at the opening of the hydrogen-oxygen reaction region. Then, the entire process is repeated.

In the hydrogen monitoring region (55) there is a hydrogen sensor (56) which is used on an ongoing basis to detect whether there is hydrogen in this region as a result of a fault or defect. If hydrogen is detected, the safety valve (52) is opened, so that the hydrogen can escape, and the ignition is interrupted. As a result, the hydrogen-oxygen reaction can never exceed the intended extent.

To determine the leaktightness of the circulating systems and of the inert gas tank, the control device (1) determines the quantity of hydrogen consumed and references it against time or the volume of fluid converted, and if a limit value is exceeded, messages are emitted to the seals and the reaction cycles are shortened or the hydrogen-oxygen reaction is boosted. The same effect can be achieved by means of a fuel cell, the hydrogen side of the fuel cell being supplied via a hydrogen tank and the air side being evacuated by the inert gas tank, and the current circuit of the fuel cell being closed. In the fuel cell, the hydrogen supply and the current circuit and the oxygen determination can be controlled by means of the electrical energy generated, such as voltage and current. Further protection against corrosion results from the method whereby the penetrated oxygen or constituents of the air and, from this, approximately the oxygen is determined, and if oxygen limit valves are exceeded, further strategies, such as warning messages relating to the sealing, oxygen-bonding or making the oxygen bonding more intensive, can be initiated.

For this purpose, it is possible to determine the quantity of the oxygen-bonding substance which is consumed, such as hydrogen or iron or magnesium, or the quantity of substance generated in the oxygen-bonding reaction, such as water or iron oxide, or the energy generated during the reaction, such as flame temperature and duration of combustion, or electric power or propagation rate and duration of the hydrogen-oxygen reaction, or, by keeping the reaction constant, a simplified value, such as duration of the reaction or duration of the supply of oxygen-bonding substance or electric current which is generated.

Recording of the change in pressure in the inert gas tank (17) over the course of time, and from this determination of the supply of air and from this approximately the penetration of oxygen, also improves the protection against corrosion.

Further increased demands imposed on unpressurized circulating systems and therefore also better functionality are shown in FIG. 1 on the basis of the exemplary embodiment of the solar collector circulating system (9). Solar collectors may be arranged at a very high position compared to the fluid level of the reservoir. This may require a high operation energy for filling and pressure-holding. The use of modern pumps for pressure generation (5) with a high efficiency and the use of an energy recovery device (12) can solve this problem. For this purpose, a small turbine (12), which is driven by the flow of the circulating system and which, for example, drives an electric generator, is arranged beneath the return in the inert gas tank. Good efficiency can be achieved by means of an adjustable nozzle, which on the one hand allows pressure-holding and on the other hand optimally diverts the return jet onto the turbine blades. If DC generators and motors are used for the pump, it is possible for the direct current obtained to be fed into the pump by means of a simple control circuit.

If the generator current and voltage are simultaneously used as measurement variable for the flow or the through-flow volume for control and monitoring purposes, a device of this type becomes economically viable.

However, other energy generation devices, such as compressors or mechanical transmission to the pump or other devices, may also be suitable and expedient if systems of this type are already present.

The solar collector circulating system (9), in the event of demand for recirculation, is filled with the storage fluid by the filling device (5) by the solar control, and the fluid is fed via the return via the energy recovery (12) and the lime/iron filings filter into the stratification tube (16) of the reservoir. Normally, the high flow velocity and turbulence during filling would result in extensive mixing of the storage fluid, and the stratification in the reservoir would be adversely affected. Feeding the fluid from the return into the stratification tube avoids this problem and means that even during filling the fluid is returned to the layer at the same temperature. The gas section which the return fluid has to cover in the inert gas tank causes the gas bubbles to be released and collected in the inert gas tank (17). When the circulating system has been filled, for example after a period of time has elapsed, or in this circulating system more appropriately when the generator has reached a defined voltage, the circulating system is switched over to the recirculation and pressure-holding mode.

For solar circulating systems, it is expedient for the pressure holding to be matched to the current temperature, so that the current pressure in the circulating system is produced just above the boiling pressure for the current temperature. This saves operating energy, since the solar circulating system (9) must be operated in a wide and high temperature range and then only the pressure energy for the current temperature has to be generated. This can be generated by closed-loop or open-loop control of the device (12) generating back pressure, such as in this case the opening of the nozzle, and simultaneous closed-loop or open-loop control of the power of the pressure generation, so that the desired flow is established.

Protection against frost represents a further function for circulating systems which are at risk from frost, on the basis of the example of the solar collector circulating system (9). In the case of unpressurized circulating systems, emptying of the circulating system to protect against frost can be achieved in an expedient way and with little outlay. Compared to glycol-filled circulating systems operated with heat exchangers, as are used in current installations, the solar collector circulating system (9) has the advantage that the efficiency is increased in two ways, firstly through the use of water as heat-transfer medium, which has a higher heat storage capacity than the water-glycol mixture, and therefore less liquid can be circulated for the same quantity of heat transfer, and secondly the avoidance of the heat exchanger, since the heat exchanger, unlike the unpressurized solar circulating system (9), can never release the entire quantity of heat to the reservoir. This results in an increased temperature in a heat exchanger circuit and therefore a greater temperature gradient at the insulations and in the collector, and therefore increased heat losses.

The solar circulating system is emptied firstly by the return ending in the gas space in the inert gas tank. If the pressure generation arrangements for the filling, recirculation and pressure-holding are shut down, for example by the solar control unit (3) removing the demand for circulation on account of the lack of insolation, the gas rises out the inert gas tank into the return, and the fluid runs into the reservoir. At the same time, the emptying valve (10) is opened, so that the circulating system is emptied quickly and completely and filled with the gas pressure of the inert gas tank. This results in protection against corrosion and also protection against frost for the circulating system. Moreover, the solar collector can no longer boil when the reservoir has reached its heat absorption limit and insolation is still present. In conventional installations with pressure circulating systems, a diaphragm vessel is provided for this purpose, which takes up the pressure and liquid expansion which results from boiling. In the case of large solar collectors or large storage volumes, the expansion vessel also has to be correspondingly large. These large expansion vessels are only produced in small numbers, making them correspondingly expensive. This represents an obstacle to the use of relatively large solar installations and reservoirs to boost heating. These disadvantages are avoided by the emptying arrangement and by unpressurized circulating systems, since they do not require expansion vessels and the unpressurized store can absorb the expansion volume through heating of the fluid.

In the case of stratification tubes, in which medium can only be fed in from below, the opening of the return ends in the fluid region. In this case, for emptying purposes a further valve-controlled emptying line is routed from the return into the gas region of the inert gas tank. It is advantageous for the two emptying lines to be combined outside the inert gas tank, so that the inert gas tank does not require any design variant. The separation of the gas from the fluid during filling or recirculation is effected by the stratification tube in the case of a return which opens out in the storage fluid. The gas rises upward in the stratification tube and is collected in the inert gas tank (17). Mixing of the reservoir by the gas bubbles is avoided, since the bubbles rise in the stratification tube.

The emptying of the circulating system or return to the reservoir without an inert gas tank, so that the fluid gas exchange takes place with atmosphere, is also appropriate if, for example, corrosion-resistant materials are used in the heating system.

In addition to emptying of solar circulating systems, it is also appropriate to be able to empty further circulating systems to protect against frost, for example if storage materials for storing heat are located outdoors and are only heated via circulating systems. In this case, the circulating system insulations or heat exchanger insulations need only be designed for solar use and can be emptied in the event of low temperatures in order to protect against frost. The emptying of circulating systems for obtaining heat or cooling also brings advantages. If a plurality of circulating systems are to be emptied, it is economic for a central emptying device to be able to empty a plurality of circulating systems of a heating system.

The emptying of solar cycle circuits to protect against frost has not hitherto gained widespread acceptance, since the reliability of emptying was hitherto only incompletely resolved. Reliable emptying has to be ensured, since just a single failure of emptying in the event of frost would destroy the solar collector. There are many fault sources which can cause a failure to empty, such as for example the destruction of outer insulations, mechanical defects in the emptying valve, reliability faults in the electronics and sensors and mechanical elements, defects in the electronics and sensors, software errors in the control systems. Reliable emptying can be ensured by sensors which record a fault and/or by means of redundant elements and/or by means of repetition processes and/or by means of autonomous additional devices with numerous variant embodiments, so that the economics of the methods can be configured according to the complexity of the installation.

In the example shown in FIG. 1, reliability faults or defects or software errors which would cause the application of pressure to be switched on incorrectly or the emptying valve to be closed incorrectly are counteracted by means of a linked-circuit actuating voltage. A plurality of redundant units, such as the solar control (3), a redundant thermostat (2) and the control device (1), have to provide consent to actuation of the application of pressure (5) and to the application of voltage to close the emptying valve (10). Even the lack of consent from just one of the three devices (1, 2, 3) leads to the voltage-free state of the application of pressure (5) and of the emptying valve (10) and therefore to the safely emptied, frost-proof state of the solar circulating system (9). The redundant thermostat (2) measures the temperature in the lower range of the solar collector and is set such that it gives its consent at temperatures above the frost range, for example 5° C.

Faults in the circulating system or defects in the emptying valve can be detected by the sensor (7) recording the absence of water. The sensor which records the absence of water may be a simple magnetically actuated contact which is switched by means of a displacement-limited float a floating position, i.e. in the presence of water and a different, gravity-related position, i.e. in the absence of water. If an absence of water does not occur during emptying, the control device (1) starts the filling device, repeats the emptying and tests for the absence of water. This operation can be repeated a number of times. If there is still no absence of water, it is attempted to flush the emptying line with the emptying valve (10) a number of times, with the empting valve open, by means of the filling device; filling and emptying cycles of the circulating system may also be incorporated in the mean time. The frequent repetition of these filling, emptying, rinsing and testing for absence of water cycles allows sporadic malfunctions and reliability malfunctions of the sensor checking for the absence of water, the control device and the emptying valve, as well as releasable blockages, such as frozen sections of pipe or soiling deposits, to be bypassed or eliminated. Messages of acoustic and optical nature from these cycles can also be used to initiate maintenance work.

The sensor checking for the absence of water can also be monitored by the flow sensor function of the generator (12) by measuring the emptied water quantity, and in the event of plausibility errors a redundant emptying line with a redundant emptying valve can be opened. The redundant thermostat (2) can also actuate the redundant emptying line with the valve at temperatures below the frost-proofing temperature, e.g. 5° C. The redundant emptying line protects against a blocking malfunction of the emptying line and emptying valve which cannot be eliminated by the use of pressure, heat and repetition.

The concomitant recording and listing of safety strategies which have been initiated and/or the failure to empty immediately makes it possible to indicate the faulty components at an early stage and to replace them before damage occurs.

In installations in which the water level of the reservoir penetrates into those parts of the circulating system which are at risk from frost, it is proposed to use a filling device with emptying feature for the circulating system as illustrated in FIG. 2. This solar circulating system (9) is separated from the reservoir by the blocking valve (43) for emptying purposes. The diaphragm vessel (40) which is acted on by pressure during filling is rendered pressure-free, by opening the pressure relief valve (42), in order for the circulating system to be emptied, and the inert gas from the diaphragm vessel can flow back into the inert gas tank as a result of the fluid pressure in the circulating system. The fluid from the circulating system flows into the diaphragm vessel and inert gas flows into the circulating system via the return of the latter. This provides protection against frost.

To fill the circulating system, after the pressure relief valve (42) has closed, inert gas is sucked out of the inert gas tank (17) by means of a small compressor (41) and is applied to the diaphragm vessel. As a result, the fluid is displaced back into the circulating system and the inert gas in the circulating system escapes via the return into the inert gas tank (17). With a constant power of the compressor (41), the filling can be terminated after a defined time has elapsed, by the compressor being switched off. Otherwise, it is also possible for sensor signals, such as fluid levels in the diaphragm vessel or fluid levels in the circulating system, or incoming flow volumes measured using the flow sensor (6), to be used to end the filling operation. The pressure in the diaphragm vessel is held by the nonreturn valve (11), so that the diaphragm vessel remains ready for emptying during circulation and pressure-holding. The blocking valve (43) is opened for recirculation and pressure-holding (39).

As an alternative to the compressor (41), it is also possible to use other pressure systems, such as compressed gas store, pumps or domestic water systems with water from which the oxygen has been bonded, the water being drained out during pressure relief using the pressure relief valve (42).

The diaphragm vessel (40) may also be replaced by a closed water-receiving vessel (FIG. 7, 75) with an emptying valve (76) in the connection to the circulating system. To keep the water-receiving vessel (75) ready for emptying, it is emptied into the reservoir by a filling device. To ensure readiness for emptying, the water-receiving vessel (75) is provided with an overflow (78), so that it is always possible to empty into the water-receiving vessel, even if the filling device has failed or water is incorrectly flowing through the blocking valve (43). A siphon (77) in the overflow prevents the ingress of air.

In installations which have such a high fluid level that the filling of the circulating system can be effected with application of pressure to the circulation and pressure-holding (39), or in which a filling device, such as a pressure pump, is installed directly in the circulating system, there is no need for the compressor (41) or the pressure system, which is replaced by a tube connection and the pressure relief valve (42) is placed into the connection from the diaphragm vessel or vessel to the circulating system. In this case, the diaphragm vessel or vessel is emptied by holding the pressure relief valve (42) open and holding the blocking valve (43) closed at the start of filling or circulation and pressure-holding, so that the diaphragm vessel (40) or vessel is emptied. After the diaphragm vessel (40) or vessel has been emptied, the pressure relief valve (42) is closed, thereby maintaining readiness to empty the circulating system, and the blocking valve (43) is opened in order to circulate the storage fluid. If the tank is operated in unpressurized form, an overflow of the tank ensures readiness for emptying even in the event of faults.

The strategies used to ensure emptying can also be applied to the arrangements described above.

In FIG. 2, a distribution device (44) is installed in the inert gas tank beneath the return of the circulating system (9). This could, for example, be a funnel which is open at the top with perforations. The fact that it is open at the top makes it easy for macro-bubbles to escape, and the funnel shape automatically matches the flow through the perforation as a function of the through-flow volume, so that the funnel does not overflow. By means of the perforation, the fluid is distributed into thin flow streams, so that on the one hand it is easy for micro-bubbles of gas to escape and on the other hand the iron filings filter beneath it is washed bright so as to retain its ability to react.

In circulating systems which are located very high above the fluid level of the reservoir, the dynamic pressure-holding may be rendered uneconomical by the operating costs.

To gain height, it is then proposed that the fluid level be arranged as high as possible. In the simplest case, this can be achieved by a store which is fitted at a correspondingly high level and, by way of example, extends over several stories of a building.

However, this requires a continuous construction running vertically over several stories of a building, which is often not available, in particular in existing buildings.

To solve this problem, the vertical arrangement of a plurality of unpressurized reservoirs (FIG. 7) is proposed, with the lower reservoirs (66, 67) closed and the upper store(s) (61) equipped with inert gas tanks (17). Fluid exchange can be effected by means of connections (64, 65, 62, 63) from and to in each case the next store up. As a result of the connections (64, 63) of the stratification tubes (16), the coupled reservoirs behave as one large store but do not have to be positioned vertically above one another and may also be supplemented by parallel reservoirs. This arrangement offers the advantage that the reservoirs can be distributed between rooms of a building, and the insulation losses thereby heat these rooms.

The use of the reservoir assembly, of the connections (62, 63, 64, 65) and of the stratification device (16) as feeds and returns for circulating systems saves outlay on piping. Therefore, returns from circulating systems end and/or feeds for circulating systems start in the reservoir assembly or in the connections (62, 63, 64, 65), and/or connections for returns from circulating systems lead out of the stratification passages (16).

By way of example in the case of reservoirs arranged in parallel in the reservoir assembly, it may also be expedient, for charging or discharging control, to optionally produce or suppress the exchange of fluid. This can be effected by shutting off the connections (62, 63, 64, 65) by means of valves.

If it is impossible for any reservoirs to be set up in the rooms, it is possible to install an arrangement as shown in FIG. 9. For this purpose, the inert gas tank (17) is arranged at a height which corresponds to the desired fluid level and is connected to a closed store (85) via a fluid-filled or gas-filled line (84). In addition, a fluid store (83) may be arranged in the line for fluid compensation during filling and emptying of circulating systems and to absorb the thermal expansion of the fluid. This line advantageously opens out in the stratification tube (16) or at the highest point of the reservoir, so that gas bubbles can rise up into the inert gas tank. The fluid compensation may also take place in the connection (84), if this latter is designed to be sufficiently large, so that the fluid tank (83) can be dispensed with. Variant embodiments of the arrangement consist in the inert gas tank with the connection and the reservoir being closed or the inert gas tank (17) having an opening being immersed in the fluid tank (83) or the connection. It is advantageous for returns from circulating systems to end in the connection (84) and/or feeds for circulating systems to begin in the connection (84).

A further option for a device which increases the fluid level for provision or retention in circulating systems comprises a pressure-holding seal between the reservoir or fluid tank and the inert gas tank or a gas tank and a gas pressure in the tank. The gas pressure is kept static or is dynamically variable, for example by means of pressure relief via a valve into a gas storage tank and build-up of pressure via a compressor with intake from the gas storage tank or by means of a diaphragm vessel which, to build up pressure, uses the pressure from a compressor or a domestic water system or a pump, it being possible for the pressure to be relieved. It is possible to empty and fill circulating systems by means of the dynamic variability of the gas pressure.

To summarize, the following options result for the device which increases the fluid level. This device may comprise a circulating system and/or store assembly and/or store and/or inert gas tank (17) arranged at an appropriate height and/or a circulating system and/or store assembly and/or store and/or inert gas tank which is under or has been placed under gas pressure and/or fluid pressure.

The recovery of heat from the waste water is made economical by means of the unpressurized store and the arrangement of tanks or double walls or double floors (FIG. 8, 69). For this purpose, the control device (1) measures the temperature in the waste water feed line (71) and the temperature in the waste water region (68). If the temperature in the feed line is greater than in the waste water region, the waste water valve (70) is closed. The waste water flows across the waste water region and exchanges its heat at the reservoir or in part itself functions as a store. Otherwise, the waste water valve (70) is opened and the waste water flows directly into the waste water discharge line (73). To increase the heat recovery energy, it is expedient for the temperature to be reduced as far as possible in the lower region of the reservoir (67). This is achieved by fitting a preheating tank for service water or by removing storage fluid for preheating in the region of heat recovery.

Obtaining of heat from waste heat or cooling systems can also be effected from other sources and this heat can be stored in the reservoir or fluid tank or store assembly.

For this purpose, it is expedient to obtain heat using a heat exchanger or storage heat exchanger which is located in or at the reservoir or store assembly or fluid tank, and/or for the storage fluid to be directly circulated through a heat exchanger or storage heat exchanger, allowing heat to be obtained.

The heat can be obtained from waste water, from cooling systems for machines, motors, compressors, generators, electronics, photovoltaic modules, fuel cells, chimneys, exhaust gases, floors, liquid pools or tanks, components, such as parts of buildings, boundary components, vision protection components, streets, roads, driveways, squares, transparent heat insulations. To increase the temperature, it is advantageous for the sources for obtaining heat to be provided with a layer or layers or films which absorb light and convert it into heat or to admix one or more attachments. The fitting of a transparent attachment or attachments allows the sources for obtaining heat to be improved further.

The fluid is only fed into the heat-obtaining exchanger if the fluid (72) supplied is warmer than the fluid which is within the heat-obtaining exchanger (69) or the surroundings of the heat-obtaining exchanger, or the storage fluid is only circulated through the heat exchanger or storage heat exchanger if storage fluid which is cooler than the temperature of the source for obtaining heat is available.

To increase the efficiency with which heat is obtained, it is advantageous for fluid for preheating purposes to be removed in the vicinity of the heat-obtaining exchanger or the removal of the storage fluid for obtaining heat or in the heat-obtaining layer in the reservoir, or for a preheating tank to be located in this location. The preheating may, for example, be used for preheating for service water or for preheating for building walls or ceilings or buffer spaces or glasshouses.

If the protection against corrosion permits, the heat exchanger or storage heat exchanger or preheating tank may be part of the reservoir or fluid tank or store assembly, for example a double floor or a double floor section or a double wall section or a double wall. Otherwise, separate tanks or heat exchangers or storage heat exchangers are to be used.

In addition to the solar collector circulating systems, it is also possible for other external cycle circuits or cycle circuits not protected against frost, such as cycle circuit for heating and removing of heat from storage materials or storage solar collectors or for obtaining heat or for cooling for protection against frost and/or for avoiding boiling in circulating systems, to be emptied.

The heating system can also realize systems which, instead of the fluid heat reservoir (14), are equipped with a fluid gravel store or a store assembly (FIG. 8), for example as described in claims 33 to 36. Heating systems in which the fluid heat reservoir is replaced by an unpressurized fluid tank or a fluid tank with reduced superatmospheric pressure or a fluid tank with a fluid level, such as a heat exchanger or a storage heat exchanger or an intermediate store or a fluid-receiving tank or a heating boiler, can also be realized. This is advantageous, for example, if other storage materials are used to store the heat. Combinations with the abovementioned types of store, which may likewise be equipped with the features described in claims 33 to 36, also result in an economic heating system of the type described in claim 1.

The proposed heating system can be operated in unpressurized form or with a reduced superatmospheric pressure or with a superatmospheric pressure. An unpressurized heating system is desirable, since it is then possible to make use of all the advantages, such as saving on materials and gas permeability of the materials. However, in the transition phase or in existing heating systems which can only be converted to unpressurized operation at considerable cost, it is also expedient to use a heating system with a reduced superatmospheric pressure or simply with superatmospheric pressure. In addition, the heating system can also be operated in subatmospheric pressure mode, in which case the corrosion prevention devices according to the invention also make a contribution. Operation with combinations of unpressurized or partially pressurized or subatmospheric pressure in different parts of the heating system is also possible.

Depending on the arrangement of the heating system, it is possible for the fluid level(s) to be located in the reservoir and/or in an inert gas tank and/or in a fluid tank and/or in one or more circulating systems and/or in a connection to the inert gas tank and/or in the stratification device and/or in fluid-receiving tanks.

By way of example, to provide the fluid on demand in the circulating systems, it is also expedient for the pressure-generation power or flow velocity or the through-flow volume or the heat quantity of the circulating system to be subject to closed-loop and/or open-loop control as a function of the current pipe mains resistance.

For the range of functions of the heating system, it is possible for sensors, such as temperature sensors, flow or through-flow sensors (6, 12, 27, 30, 36), pressure sensors, fluid level sensors and sensors detecting the absence or presence of fluid (7), to be arranged in the circulating system and/or in the reservoir or fluid tank (14) and/or in and at the inert gas tank (17).

To provide, circulate, empty, hold the pressure of and retain fluid in circulating systems, it may be advantageous if a central device, such as filling device or emergency filling device or a device for increasing the fluid level, in a heating installation operates all the cycle circuits simultaneously or independently of one another by being switched over to the particular cycle circuit.

To increase the storage density, it is advantageous for latent heat reservoirs to be integrated in the reservoir or store assembly or fluid tank or fluid gravel store.

### List of Reference Symbols

1 control unit
2 thermostat
3 solar control unit
4 heating control unit
5 pressure generation for filling, pressure holding and circulation
6 flow sensor
7 sensor for detecting the absence of fluid
8 temperature sensor
9 solar collector
10 emptying line with emptying valve
11 nonreturn valve
12 pressure holding with energy recovery
13 iron filings structure and lime filter
14 unpressurized fluid heat reservoir
15 oil layer
16 stratification tube
17 inert gas tank
18 oxygen-bonding unit
19 stratification tube
20 pressure-holding valve
21 iron filings structure and lime filter
22 iron filings structure and lime filter
23 mixing valve
24 pressure generation for filling, pressure holding and circulation
25 nonreturn valve
26 recirculation pump
27 flow sensor
28 emptying line with emptying valve
29 heating heat exchanger
30 flow sensor, binary
31 emergency filling device with hand pump
32 service water heat exchanger
33 emergency filling with recirculation pump series connection
34 recirculation pump
35 nonreturn valve
36 flow sensor, binary
37 heating boiler
38 blocking valve
39 pressure generation for pressure holding and circulation
40 diaphragm vessel
41 pressure generation system
42 pressure relief valve
43 blocking valve
44 distribution device
45 iron filings structure and lime filter
46 domestic water system
47 filling valve
48 nonreturn valve
49 level-controlled valve
50 so filling vessel
51 filling valve
52 outlet valve
53 hydrogen-oxygen reaction region
54 ignition means
55 hydrogen monitoring region
56 hydrogen sensor
57 reaction flow sensor
58 hydrogen inlet valve
59 hydrogen flow sensor
60 hydrogen tank
61 open store
62 store connection
63 store connection, stratification
64 store connection, stratification
65 store connection
66 closed store
67 closed store
68 temperature sensor, waste water region
69 double floor, waste water region
70 bypass for waste water region
71 temperature sensor, waste water feed line
72 waste water feed line
73 waste water discharge line
74 oxygen bonding
75 water-receiving tank
76 emptying valve
77 siphon
78 overflow
79 connection to the reservoir
80 gas connection to the inert gas tank
81 circulating system connection to the inert gas tank
82 filling device
83 fluid tank
84 connection, inert gas tank store
85 fluid heat reservoir

1-77. (canceled)

78. A heating system for generating and distributing thermal energy, comprising:
at least one unpressurized fluid heat reservoir containing a storage fluid;
one or more circulating systems for distributing heat to at least one of heat-exchanging and storing components; and
at least one of said circulating systems being directly connected to said at least one fluid heat reservoir for circulating said storage fluid through said circulating system.

79. The heating system according to claim 78, which comprises an inert gas tank.

80. The heating system according to claim 79, wherein said inert gas tank is disposed above a level of said storage fluid in said fluid heat reservoir and is in communication, by way of a gas-permeable opening, with said fluid heat reservoir or a stratification device disposed thereat, whereby gas bubbles from said fluid heat reservoir, said stratification device, or one of said circulating collect in said inert gas tank.

81. The heating system according to claim 78, wherein one or more of said circulating systems are systems for generating heat.

82. The heating system according to claim 81, wherein one or more of said circulating systems are solar cycle systems.

83. The heating system according to claim 78, which comprises a provision device selected from the group consisting of a filling device and a device for increasing a fluid level in said fluid heat reservoir, said device introducing the fluid into the circulating system prior to circulating.

84. The heating system according to claim 83, which comprises a control device connected to said provision device, wherein said provision device initiates a circulation system when circulation is required under control of said control device, and wherein a circulation mode and pressure-holding mode is set under at least one of time control, open-loop control, closed-loop control, and sensor control.

85. The heating system according to claim 78, which comprises a retention device for holding said fluid in said circulating system.

86. The heating system according to claim 85, wherein said retention device comprises a device for blocking and/or sealing off said circulating system.

87. The heating system according to claim 86, wherein said device for blocking and/or sealing is configured such that, when said circulating system is blocked off for retention purposes, a generation of pressure for at least one of pressurizing, pressure-holding, and circulating is switched on until a blocking operation has ended.

88. The heating system according to claim 78, which comprises means for holding said fluid in said circulating system, said means comprising a device for cyclical or event-controlled or constant minimal circulation or said means comprising recirculation phases when inoperative.

89. The heating system according to claim 78, which comprises emptying lines for emptying a circulating system, said emptying lines opening into one of an inert gas tank, above said fluid heat reservoir, and to a stratification device disposed in said fluid heat reservoir.

90. The heating system according to claim 78, which comprises emptying lines for emptying a circulating system, said emptying lines being formed by feed and return lines of said circulating system and being valve-controlled, said lines merging outside said inert gas tank or fluid heat reservoir or stratification device into a common line and said common line opening into an inert gas tank or to said fluid reservoir or to a stratification device in said fluid reservoir.

91. The heating system according to claim 79, which comprises a valve-controlled emptying line for said circulating system, said emptying line connecting to a feed of said circulating system outside said inert gas tank or said fluid reservoir or a stratification device, and opening into a return ending in a gas region of said inert gas tank or above or in said fluid reservoir or above or in said stratification device.

92. The heating system according to claim 78, which comprises a device for emptying a circulating system or a part of a circulating system directly coupled to said fluid reservoir, and wherein a fluid level of said fluid reservoir projects into a region to be emptied.

93. The heating system according to claim 78, which comprises a device for increasing a fluid level in the system.

94. The heating system according to claim 93, which comprises a liquid-filled and/or gas-filled connection, formed with a fluid-receiving space, disposed between a closed reservoir and an inert gas tank disposed thereabove.

95. The heating system according to claim 93, wherein said device for increasing the fluid level comprises a pressure-holding seal between said fluid reservoir and a gas-pressurized inert gas tank.

96. The heating system according to claim 93, wherein said device for increasing the fluid level comprises one of a reservoir and a reservoir assembly disposed at a given height.

97. The heating system according to claim 78, wherein said heat fluid reservoir is a device selected from the group consisting of a storage heat exchanger, a fluid-receiving tank, a plurality thereof, and a combination thereof.

98. The heating system according to claim 97, wherein said storage heat exchanger or said fluid-receiving tank forms part of a reservoir assembly.

99. The heating system according to claim 98, wherein said reservoir assembly comprises a double base or a double wall.

100. The heating system according to claim 98, wherein said reservoir assembly comprises a plurality of reservoirs disposed above one another, wherein lower reservoirs are closed, and said reservoirs are coupled to a respectively adjacent reservoir by way of at least one connection for rising fluid and gas and by way of at least one connection for sinking fluid.

101. The heating system according to claim 100, wherein said reservoirs are disposed a lateral offset relative to one another, and said reservoirs are connected in parallel individually or in groups.

102. The heating system according to claim 100, wherein said reservoirs include stratification devices connected via said connection, for assuring a stratified arrangement over a plurality of said reservoirs.

103. The heating system according to claim 78, which comprises a heat generator selected from a waste heat unit and a cooling systems, and wherein heat from said heat generator is stored in said reservoir.

104. The heating system according to claim 103, wherein the system is configured to feed fluid into a heat-obtaining exchanger only if the fluid is warmer than the fluid in the heat-obtaining exchanger or than an environment of the heat-obtaining exchanger, or wherein the system is configured to circulate the storage fluid through the heat exchanger or storage heat exchanger only if storage fluid is available at a lower temperature than a temperature at said heat generator.

105. The heating system according to claim 78, which further comprises a device for dynamic pressure generation and a device for generating a back-pressure, said devices being configured such that a defined part of the pressure generation is reflected in an increase in pressure in the circulating system but not in an increase in through-flow.

106. The heating system according to claim 78, which comprises a floating layer of a liquid that is immiscible with said heat storage fluid disposed on said heat storage fluid.

107. The heating system according to claim 106, wherein said floating layer is a layer of paraffin oil.

108. A method of operating a heating system, which comprises:
providing a heating system according to claim 78;
providing the heating system with a reliable emptying device and ensuring, by way of at least one of redundant elements, repetition operations, and autonomous additional devices, reliable emptying of the system.

109. The method according to claim 108, which comprises assuring reliable emptying of the circulating systems by recording with a sensor at least one of an absence or presence of water and an emptied quantity of water, and initiating further safety strategies with sensor signals issued by the sensor.

110. The method according to claim 109, wherein the further safety stategies are selected from the group consisting of emptying repetitions, flushing operations, and heating operations.

111. The method according to claim 108, which comprises mounting redundant or autonomous elements for reliable emptying of the circulating systems and switching or evaluating the elements to execute redundant function and/or, in an event of a plausibility of an error, initiating safety strategies.

112. The method according to claim 111, wherein the elements are selected from the group consisting of thermostats, temperature sensors, and valve-controlled emptying lines.

113. The method according to claims 108, which comprises assuring reliable emptying of the system by providing and connecting in a chain a plurality of redundant systems for at least one of an actuation voltage for pressure-generating devices and emptying valves or blocking valves, and consenting to a generation of pressure or non-emptying by all the redundant systems, and switching off a pressure generation or an emptying as soon as a consent of one of the redundant systems is removed.

114. The method according to claims 108, wherein the autonomous additional device comprises a discharge apparatus, and the method comprises discharging the fluid from a part of the circulating system that is at risk from frost.

115. The method according to claims 114, wherein the discharge apparatus is an overflow in the fluid-receiving tank or a discharge valve with sensor control of a fluid level.

116. In combination with a heating system subject to superatmospheric pressure, the heating system according to claim 78.

117. In combination with a heating system with ambient pressure circulation systems, the heating system according to claim 78.

118. In combination with a heating system having a pressure-reduced circulation system, the heating system according to claim 78.

119. The method according to claims 108 adapted for operation of a heating system subject to superatmospheric pressure, ambient-pressure circulating systems, circulating systems with reduced superatmospheric pressure, or circulating systems that can be emptied.
